(19) United States
(12) Patent Application Publication
(10) Pub. No.: US 2010/0112515 A1
(43) Pub. Date: May 6, 2010

(54) DENTAL HANDPIECE

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/265,903

(22) Filed: Nov. 6, 2008

(51) Int. Cl. A61C 3/00

(52) U.S. Cl. 433/114

(57) ABSTRACT

A dental handpiece having an embossed non-slip grip positively wrapping about the periphery of the handpiece body at a predetermined location for gripping with the fingers.

### BACKGROUND OF THE INVENTION

1. Field of the Invention

The present invention relates to a dental handpiece and more particularly to a dental handpiece with a non-slip grip.

2. Description of the Related Art

During the treatment of teeth inside a patient's mouth, a dental handpiece maybe used to grind or drill the tooth in question.

A regular dental handpiece uses a high-speed rotating mechanism to drive a pin or drill in a bearing at the distal end of the handpiece body, thereby performing a dental treatment or operation. The handpiece body of a dental handpiece is an elongated, slightly curved bar for holding by the dentist. Due to vibration of the high-speed rotating mechanism, the hand must apply a great force to hold the narrow elongated dental handpiece positively in position. Frequently using a dental handpiece in this manner may cause injury to the dentist's hand. Therefore, an improvement in this regard is necessary.

### SUMMARY OF THE INVENTION

The present invention has been accomplished under the circumstances in view. It is therefore the main object of the present invention to provide a dental handpiece, which facilitates positive grip, reducing the risk of hand injury.

To achieve this and other objects of the present invention, the dental handpiece comprises a handpiece body, and a non-slip grip mounted on the outside of the handpiece body. The non-slip grip has its outside wall embossed for positive gripping with the fingers to facilitate gripping ease and comfort.

Further, the non-slip grip can be configured subject to a dentist's gripping requirement to facilitate gripping ease and comfort.

### BRIEF DESCRIPTION OF THE DRAWINGS

FIG. 1 is an exploded view of a dental handpiece in accordance with the present invention.

FIG. 2 is an elevational assembly view of the dental handpiece in accordance with the present invention.

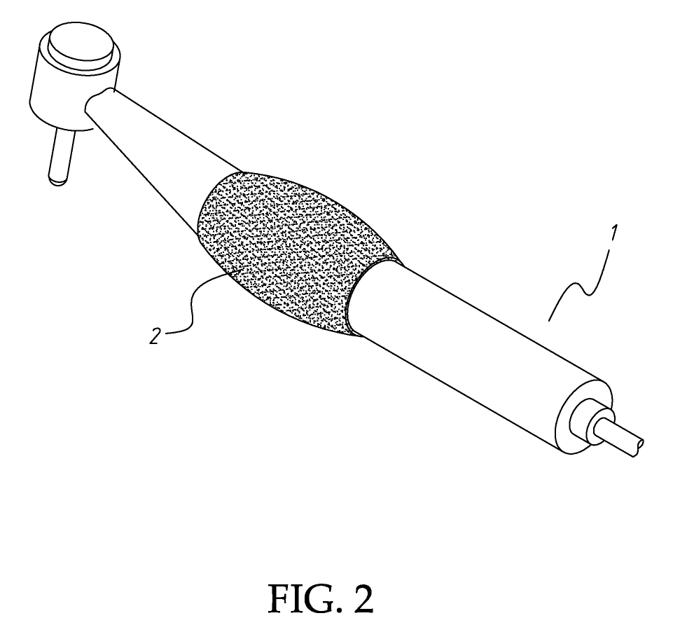

FIG. 3 is a sectional side view of the dental handpiece in accordance with the present invention.

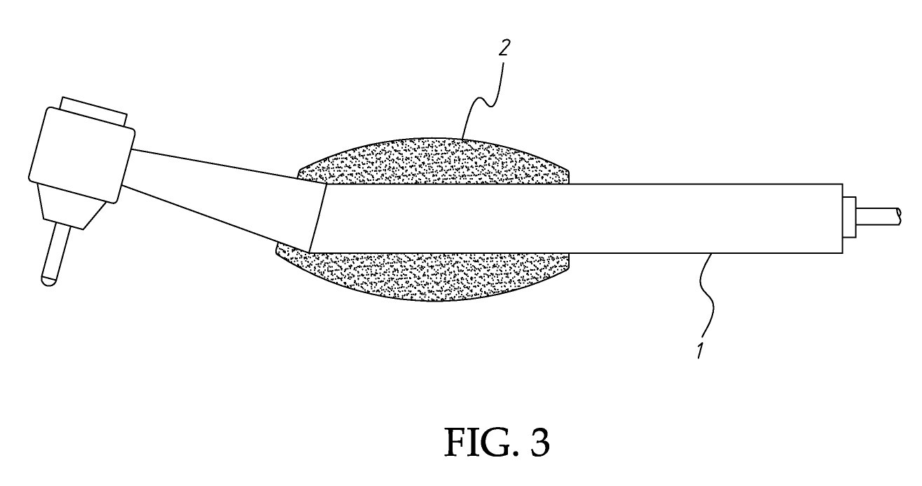

FIG. 4 is a schematic drawing showing a status of use of the dental handpiece in accordance with the present invention.

### DETAILED DESCRIPTION OF THE PREFERRED EMBODIMENT

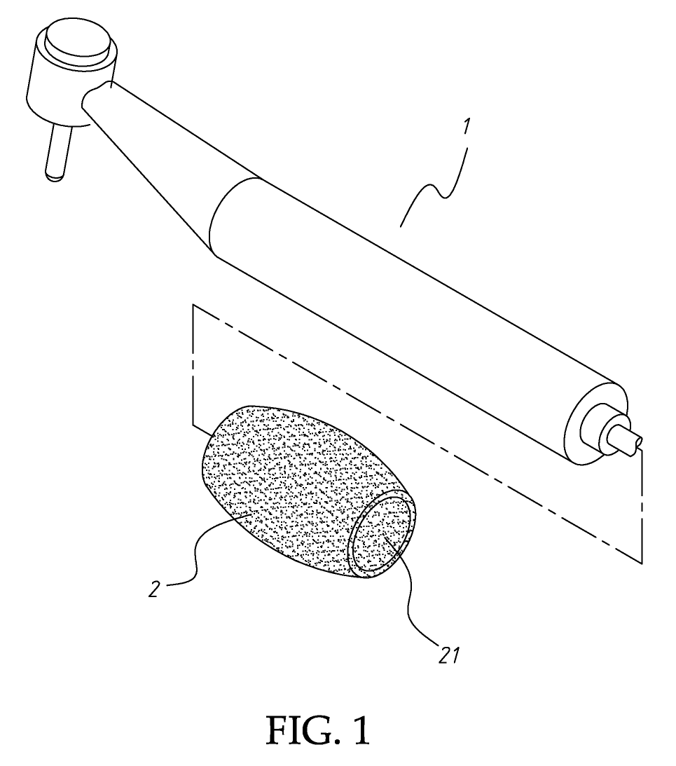

Referring to FIGS. 1˜3, a dental handpiece in accordance with the present invention is shown comprising a handpiece body 1 and a non-slip grip 2.

The non-slip grip 2 is mounted on the outside of the handpiece body 1. The non-slip grip 2 has its outside wall embossed to facilitate gripping ease and comfort. Further, the non-slip grip 2 has a through hole 21 by which the non-slip grip 2 is sleeved onto the handpiece body 1 and positioned thereon positively at the selected location convenient for gripping with fingers. After installation, the non-slip grip 2 does not move relative to the handpiece body 1. It is to be understood that the installation of the non-slip grip 2 is not limited to the sleeve joint. Alternatively, the non-slip grip 2 can be formed of two symmetrical halves bonded together to the periphery of the handpiece body 1 with an adhesive.

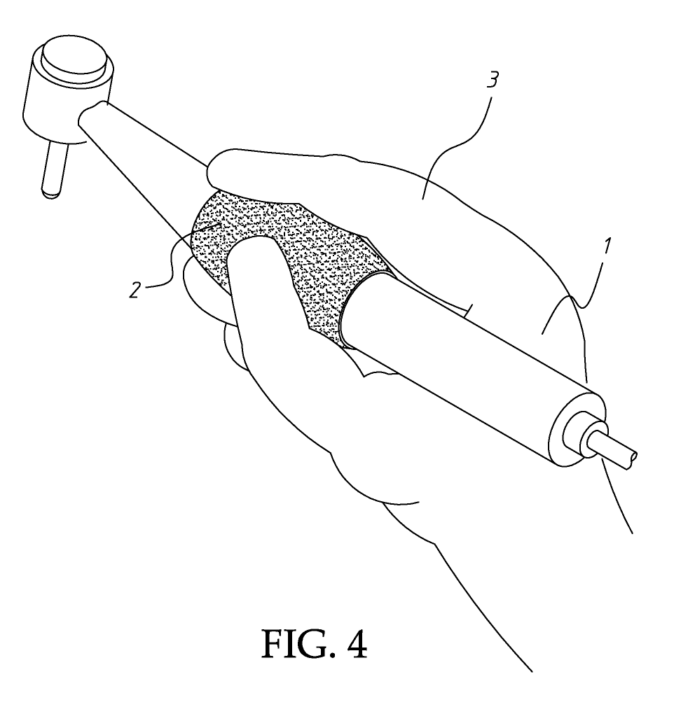

Referring to FIG. 4, the non-slip grip 2 fits a human hand's grip. When the dentist is operating the handpiece, the dentist can grip the handpiece with the hand positively and comfortably, avoiding potential injury.

Further, the non-slip grip 2 has a drum-like shape convenient for production. Further, the non-slip grip 2 may be specifically designed subject to a dentist's gripping requirement to facilitate gripping ease and comfort.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dental handpiece comprising a non-slip grip positively wrapping about the periphery of a handpiece body thereof at a predetermined location for gripping with the fingers, said non-slip grip having an embossed outside wall.

2. The dental handpiece as claimed in claim 1, wherein said non-slip grip comprises a through hole cut through two distal ends thereof that fits onto the periphery of said handpiece body positively.

3. The dental handpiece as claimed in claim 1, wherein said non-slip grip is configured to fit the gripping of a dentist.
